(19) United States
(12) Patent Application Publication
(10) Pub. No.: US 2008/0275592 A1
(43) Pub. Date: Nov. 6, 2008

(54) COMMUNICATION METHOD AND DATA STRUCTURE FOR CONTROLLING NETWORK-BASED ROBOT SYSTEM

(76) Inventor: Kyoung Jin KIM, Seoul (KR)

Correspondence Address: BIRCH STEWART KOLASCH & BIRCH, PO BOX 747, FALLS CHURCH, VA, 22040-0747, US

(21) Appl. No.: 11/925,356

(22) Filed: Oct. 26, 2007

(30) Foreign Application Priority Data
May 2, 2007 (KR) 10-2007-42786

(51) Int. Cl. G06F 19/00; G06F 15/16

(52) U.S. Cl. 700/245; 709/202; 901/1

(57) ABSTRACT

Disclosed herein is a communication method and data structure for a network-based robot system. The communication method is performed in such a way as to send subsequent packet data without waiting for acknowledgement of the reception of previous packet data by a counterpart. Each piece of packet data includes a device map section for storing information about activation and a payload section for storing data related to the activation. In order to send significant data, a transmitting end checks whether the significant data has been received by a receiving end using a response packet based on the information about activation of portions of the device map section and based on the corresponding significant data existing in the corresponding portions of the payload section. Furthermore, the transmitting end repeatedly sends the significant data until it is acknowledged that the significant data has been received by the receiving end in such a repeating way that the transmitting end activates portions of the device map section, creates packet data by including the significant data in corresponding portions of the payload section, and sends the created packet data to the receiving end.

### BACKGROUND OF THE INVENTION

1. Field of the Invention

The present invention relates to a communication method for the control of a network-based robot system and a data structure for the communication method.

2. Description of the Related Art

In the future, various types of home robots will spread to almost every household, and various functions will be performed using such home robots. One representative field of application thereof is an education field that utilizes the playing of audio and video content (hereinafter referred to as “multimedia content”) for the narration of fairy tales, English education, etc.

In a prior art home robot system, when a user connects to a service server via a home robot or a Personal Computer (PC) and obtains a specific narrated fairy tale or English learning content from a homepage free of charge or on payment of a fee, a text/audio file and video file for the content, stored in the service server, are downloaded to and stored in a home robot, and the home robot plays the narrated fairy tale or English learning content by playing the video file while issuing utterance using an audio file, resulting from conversion of a sentence through a Text-To-Speech (TTS) engine, or using a transmitted audio file at the time desired by the user. As a result, in order to play a large amount of downloaded audio and video data, the processor, memory and Hard Disk Drive (HDD) of the robot are required to have almost PC-level capacity, so that the cost of the home robot is high.

Furthermore, at the time of playing such a narrated fairy tale and English learning audio and video, the home robot just plays audio and video, but does not perform motion related to the audio and the video (for example, a robot's bowing motion or a robot's lip motion (which is synchronized with the utterance of a sentence) that is performed when the sentence “How are you?” or “Hello”), so that the interest of infants or children cannot be aroused using the narrated fairy tale or English learning content.

As a result, in the prior art home robot system, the home robot requires a high-capacity central processing unit and high-capacity memory so as to use audio and video content, and interest is not stimulated because there is no motion corresponding to audio and video.

In order to overcome the problems of the prior art, U.S. Ser. No. 11/319,433 (filed on Nov. 29, 2005) and U.S. Ser. No. 11/327,403 (filed on Jan. 9, 2006), which are the preceding U.S. patent applications of the present applicant, proposed a robot terminal system having a construction shown in FIG. 1.

In these preceding patent applications, each robot terminal 1-1, 1-2, . . . , or 1-N of a home includes a motor 2-1, 2-2, . . . , or 2-N for actuating joints and wheels, a motor drive circuit 3-1, 3-2, . . . , or 3-N for driving the motor and relay 2-1, 2-2, . . . , or 2-N, sensors 4-1, 4-2, . . . , or 4-N, including a microphone, a transceiver device 5-1, 5-2, . . . , or 5-N for transmitting sensing signals, sent from the sensors 4-1, 4-2, . . . , or 4-N, to a server 7 and receiving data, sent from the server 7, at the robot terminal 1-1, 1-2, . . . , or 1-N, a Digital/Analog (D/A) converter 6-1, 6-2, . . . , or 6-N for issuing utterances for a audio file sent from the server 7, and an image display control device (not shown) for displaying a transferred image file on a monitor when the robot terminal 1-1, 1-2, . . . , or 1-N is equipped with the monitor.

Accordingly, only a transceiver device 5-1, 5-2, . . . , or 5-N for transmitting and receiving data to and from a server 7, a sensor 4-1, 4-2, . . . , or 4-N such as a microphone, a motor/relay 2-1, 2-2, . . . , or 2-N, a motor/relay driving circuit 3-1, 3-2, . . . , or 3-N, a D/A converter 6-1, 6-2, . . . , or 6-N, a speaker 10-1, 10-2, . . . , or 10-N, and/or a video display control device and a monitor are installed in each of the robot terminals 1-1, 1-2, . . . , and 1-N, and a large amount of data processing for creating motion control data for the robot terminals 1-1, 1-2, . . . , and 1-N and for creating audio files and/or video files are performed in the service server 7. As a result, the robot terminals 1-1, 1-2, . . . , and 1-N do not require high-capacity central processing devices and high-capacity memory, so that it is possible to provide inexpensive home robots.

Meanwhile, in these preceding patent applications, a method of sending and receiving data between the service server 7 and the robot terminal 1 using a packet transmission method is used to send motion control data synchronized with voice and/or video, as shown in FIG. 2, and the same packet format is always used, as shown in FIG. 3. Since the meaning of respective fields is described in detail in the preceding patent applications, a description thereof is omitted here.

As a result, in the preceding patent applications, a method of performing communication between the service server 7 and the robot terminal 1 using packets having the same size, such as that shown in FIG. 3, is used. Accordingly, a motion control data field MD should be used even in the case where the amount of motion control data or multimedia data to be sent is not large, for example, in the case where it is not necessary to send motion control data because only an utterance is issued, so that the size of the overall data sent using a packet transmission method increases, thereby incurring communication load. As a result, a packet data format having a variable data size, which prevents the fields of data, which are not required to be sent, from being sent, is required.

Furthermore, a TCP/IP method or a UDP/IP method, which is widely used in the Internet, may be used as a method for sending packet data to a counterpart (the service server 7 or the robot terminal 1). In the TCP/IP method, packet data must be sent over the typical Internet, so that a method of making a reattempt when a packet data reception signal has not been received from a counterpart until a period twice a typical transmission period has elapses.

In the case where transmission is not performed smoothly due to a problem with a communication line, considerable load is caused on a transmitting end and a communication line due to attempts to repeatedly send the same data packet.

In contrast, when the UDP/IP method is used, the subsequent packet data must be successively sent regardless of the success of reception, so that some packets are lost in the case where a transmission line has a problem, with the result that even significant command data, which must be transferred to a counterpart, may be lost, thereby causing a problem.

For example, when packet data, including command data for issuing an emergency stop command to a robot terminal, is lost, a receiving end (the robot terminal 1) cannot receive the command data, even though a transmitting end (the service server 7) determines a situation of concern to be an emergency situation and sends the emergency stop command to the robot terminal 1, so that the robot terminal 1 cannot perform emergency stop, thereby causing a great accident.

As a result, research into a communication method and the data structure of data packets for the communication method, which are suitable for the network-based robot system, including the robot terminal 1, is required.

### SUMMARY OF THE INVENTION

Accordingly, the present invention has been made keeping in mind the above problems occurring in the prior art, and an object of the present invention is to provide a communication method that, in a network-based robot system, is capable of certainly sending significant data and minimizing the size of transmitted data, and the data structure of data packets for the communication method.

In order to accomplish the above object, the present invention provides a communication method for a network-based robot system, the network-based robot system including a service server and a robot, wherein the communication method is performed in such a way as to send subsequent packet data without waiting for acknowledgement of the reception of previous packet data by a counterpart; each of the pieces of packet data includes a device map section for storing information about activation, indicating whether data to be sent or received for each of elements of the robot exists, and a payload section for storing data related to activated portions of the device map section; and, in order to send significant data that must be sent, a transmitting end checks whether the significant data, sent by the transmitting end, has been received by a receiving end, using a response packet sent by the receiving end, based on the information about activation of portions of the device map section, and based on the corresponding significant data existing in corresponding portions of the payload section, and the transmitting end repeatedly sends the significant data until it is acknowledged that the significant data has been received by the receiving end in such a repeating way that the transmitting end activates portions of the device map section corresponding to the significant data that has not be received, creates packet data by including the significant data in corresponding portions of the payload section, and sends the created packet data to the receiving end.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a diagram showing a conventional robot terminal system;

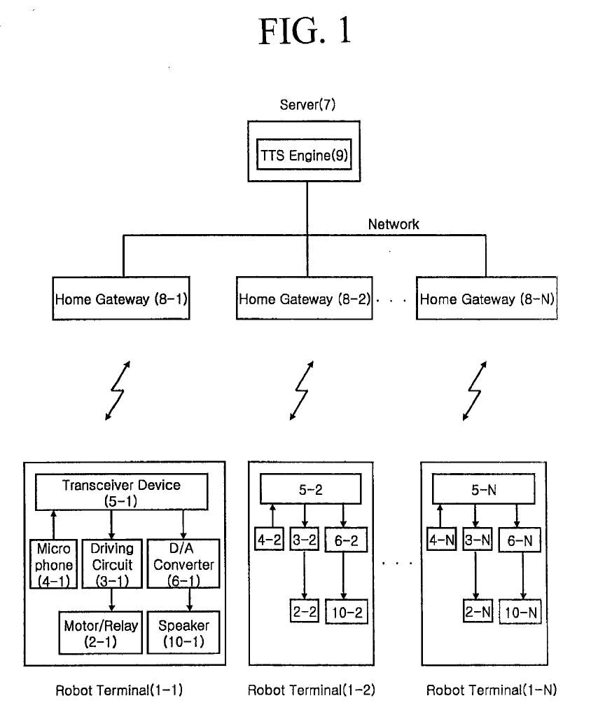

FIG. 2 is a diagram showing a communication method used in the conventional technology shown in FIG. 1;

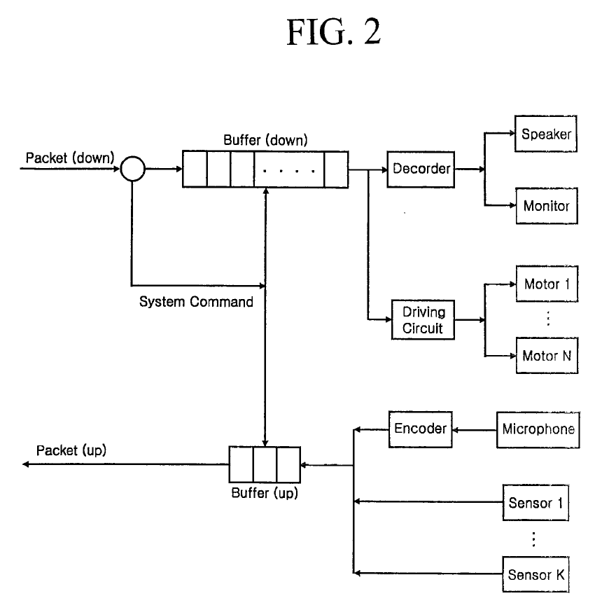

FIG. 3 is a diagram showing the format of packet data used in the conventional technology shown in FIG. 2;

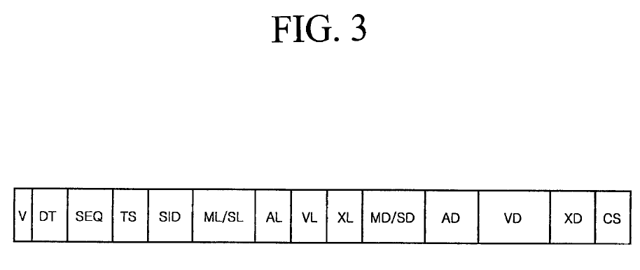

FIG. 4 is a view showing the appearance of a robot terminal for a battle game to which the present invention is applicable;

FIG. 5 is a diagram showing the packet data format of the present invention;

FIG. 6 is a diagram showing a method of sending packet data using the packet data format of FIG. 5 in the case where there is no transmission loss; and

FIG. 7 is a diagram showing a method of sending packet data using the packet data format of FIG. 5 in the case where there is transmission loss.

### DESCRIPTION OF THE PREFERRED EMBODIMENTS

Reference now should be made to the drawings, in which the same reference numerals are used throughout the different drawings to designate the same or similar components.

Principles that must be accomplished for a communication method and the data structure of data packets for the communication method, which are suitable for the network-based robot system, will be described first.

1. In order not to cause load on a transmitting end and a communication line at the time of transmitting packet data, it is preferable to employ a UDP/IP transmission method for successively sending the subsequent packet data regardless of the success of reception.

In general, in the Internet, packet data must not be lost, so that a process of certainly sending the packet data through repeated attempts when a counterpart does not receive it. Meanwhile, with regard to multimedia data including motion, having motion control data, audio data and/or video data, even if a small number of packets is not sent and is omitted from continuous packet data, a receiving end can restore the lost packets through interpolation based on the continuity of the packet data when desired, and a user mostly does not recognize the omission of the packets, even though the packet data is played with the omitted packets omitted therefrom (for example, even though part of audio data is omitted, there is no problem in a user recognizing audio because the continuity of audio signal is hardly damaged or is damaged for a considerably short time). Accordingly, for multimedia data including motion, in order to eliminate load imposed on the transmitting end and the communication line due to repeated attempts, it is preferable to successively send the subsequent packet data without waiting for a packet data reception signal from a counterpart using a UDP/IP method, even though data is somewhat lost.

2. Even though a UDP/IP method is used, a data structure for certainly sending significant data, which must be certainly sent, is required.

For example, even though the UDP/IP method is used, a scheme for certainly sending significant data, such as an emergency stop command related to an emergency situation, or information about the number of infrared bullets discharged and the number of hitting infrared bullets, which are factors to determine a win and a defeat for a battle robot terminal, is required.

Now, the packet data structure of the present invention capable of accomplishing the above-described two principles will be described below. Here, it is assumed that a battle game is performed using a robot terminal 1.

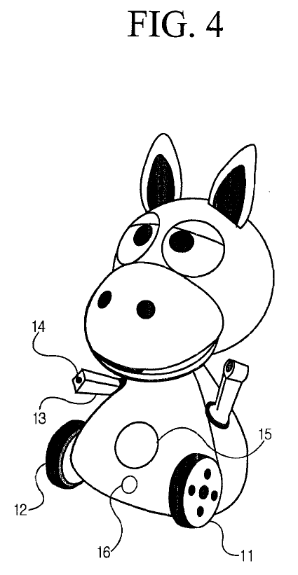

As shown in FIG. 4, the robot terminal 1 includes a left wheel 11, a right wheel 12, a right arm 13 configured to function as the barrel of a gun, an infrared transmission unit 14 disposed at the end of the right arm 13, an infrared reception unit 15 attached to the center of a body, and a proximity sensor 16 attached to the body at a location below the infrared reception unit 15. The robot terminal 1 moves using the left wheel 11 and the right wheel 12, discharges infrared bullets using the infrared transmission unit 14 while raising the right arm 13 to fire an infrared gun, takes infrared bullets, discharged from the other robot terminals, through the infrared reception unit 15, and measures a distance to a forward object using the proximity sensor 16.

For the battle robot terminal 1, right and left wheel control data related to the movement of the robot terminal 1, gun barrel control data, gun barrel monitoring data related to the monitored angles of the gun barrel of the robot terminal 1, and proximity distance data measured by the proximity sensor 16 do not cause great problems in moving the battle robot terminal 1, controlling a gun barrel and determining whether the robot terminal 1 has left a game area, even though part of the data is lost. Accordingly, for such data, the subsequent data is successively sent. Data that does not cause a great problem is referred to as insignificant data.

However, in a battle game, the number of infrared bullets discharged and the number of hitting infrared bullets are significant factors to calculate the hitting rate and determine whether bullets have been exhausted, and are significant data for determining a win or a defeat, so that an infrared bullet discharge command issued by the service server 7 or data about the number of hitting infrared bullets detected by the infrared reception unit 15 of the robot terminal 1 must be transferred. If it is determined that such data is not transferred, the data must be repeatedly sent at the time of sending the subsequent data until the data is transferred.

The reason for this is that, if the robot terminal 1 does not receive a discharge request due to a problem with a communication line or the like, even though the service server 7 has made a discharge request, the service server 7 erroneously becomes aware that an infrared bullet has been discharged, and thus increases the number of infrared bullets discharged. In this case, the robot terminal 1 does not receive the command, and thus does not discharge an infrared bullet through the infrared transmission unit 14, so that there arises a problem of erroneous calculation in calculating the hitting rate or determining the winner of a battle.

Furthermore, in the case where the service server 1 does not receive notification data due to a problem with a communication line or the like, even though the robot terminal 1 has become aware that it has been hit by an infrared bullet, discharged by a counterpart, through the infrared reception unit 15 and has attempted to notify the service server 7 of the fact, there arises a problem of erroneous calculation in calculating the hitting rate or determining the winner of a battle.

In summary, for the battle robot terminal, right and left wheel control data, gun barrel control data, gun barrel monitoring data, and proximity sensor data are insignificant data that does not cause a problem with the help of restoration, even though part thereof is lost, or does not cause a problem, even though it is not subjected to restoration, while an infrared bullet discharge command and infrared bullet detection data are significant data that must be transferred.

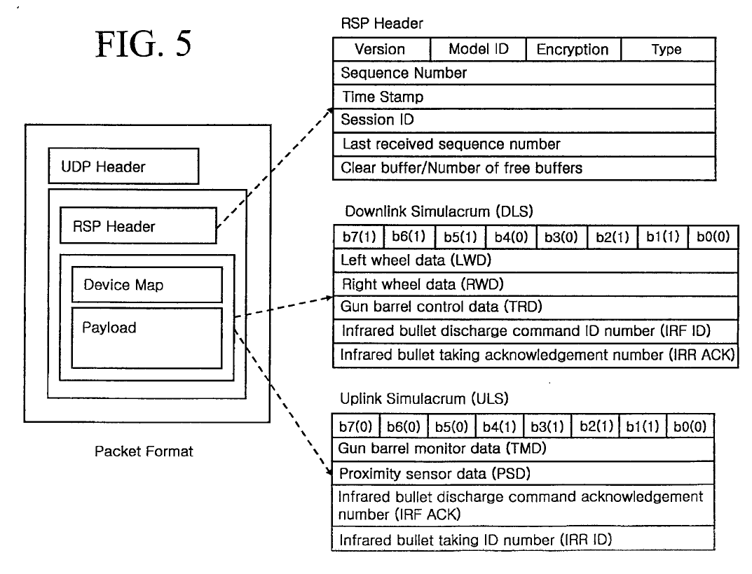

Now, the packet data structure of the present invention that enables packet data to be certainly sent such that significant data must be transferred using a UDP/IP method in a robot terminal system is described with reference to FIG. 5 below.

As shown in the left portion of FIG. 5, the packet data structure of the present invention includes a UDP header for performing UDP/IP transmission using an IP header, a Robot Simulacrum Protocol (RSP) header, a device map section corresponding to a bit section indicating the activation of respective pieces of data, and a payload section having data about the activated elements of the device map section. Here, the simulacrum refers to a shadow, a shape or a figure, and the meaning thereof will become apparent from the following descriptions of an uplink packet format and a downlink packet format.

The UDP header is a header for communication using a UDP/IP method. Since the header is well known to those skilled in the art, a description thereof is omitted here. The RSP header will be described with reference to FIG. 5 below.

The field ‘Version’ indicates a protocol version number, the field ‘Model ID’ indicates the model TD of a robot terminal, the field ‘Encryption’ indicates whether packet data has been encrypted, the field ‘Type’ indicates the type of data included in packet data (audio data, video data, motion control data, system command, ACK, etc.), the field ‘Sequence Number’ indicates the sequence of transmission of packets, the field ‘Time Stamp’ indicates the time when a packet was created, and the field ‘Session ID’ is a session ID field for the identification of a server and a robot terminal in communication with each other and security.

The last received sequence number is stored in the field ‘Last received sequence number,’ and the field ‘Clear Buffer/Number of free buffers,’ indicates whether an up buffer or down buffer has been cleared (when it has been cleared, the number of buffers is maximal) or indicates the number of available buffers. The respective fields of the robot protocol header are set and changed according to the necessity of a designer.

With regard to the device map section, when the devices (elements) of the robot terminal 1 are defined, the size and bit locations of the elements of the device map section are determined. The same device map is used regardless of transmission and reception, and is used when the service server 7 issues an activation command so as to activate each device of the robot terminal 1 or when the robot terminal 1 notifies the service server 7 of the activation of each device.

The payload section stores transmitted data that corresponds to the activated elements of the device map section.

Next, the data structure or format of the data packet section, which is the key item of the present invention, will be described in detail below.

When the service server 7 sends data to the robot terminal 1, storage is performed in a DownLink Packet Format (DLPF). In contrast, when the robot terminal 1 sends data to the service server 7, storage is performed in an UpLink Packet Format (ULPF). These are described in detail with reference to the right portion of FIG. 5 below.

The DLPF includes a device map section for activation indication bits b7, . . . , and b0 (“1” indicates activation, and “0” indicates inactivation), indicating the activation of respective pieces of data sent in the downlink packet format, in the uppermost end thereof. In the DLPF shown in FIG. 5, left wheel data LWD, right wheel data RWD and gun barrel control data TRD are activated, so that the bits b7, b6, and b5 are assigned “1” in the sense that related data exists in the payload section below. Meanwhile, the activation indication bits b2 and b1 are activation indication bits that are respectively related to an infrared bullet discharge command ID number IRF ID and an infrared bullet taking acknowledgement number IRR ACK. In FIG. 5, the activation indication bits b2 and b1 are activated, so that they are assigned “1” and the infrared bullet discharge command ID number IRF ID and the infrared bullet taking acknowledgement number IRR ACK are indicated in the payload section below.

As a result, from the activation indication bits b7, . . . , and b0 of the device map section of the DLPF shown in FIG. 5, the type of data sent by the service server 7 to the robot terminal 1 (LWD, RWD, TRD), the type of command (IRFID), and the type of acknowledgement signal (IRR ACK) received from the robot terminal 1 can be entirely and immediately detected.

In the same way, in the ULPF, activation indication bits b4 and b3 have been activated to “1” because gun barrel monitoring data TMD and proximity sensor data PSD are used, and activation indication bits b2 and b1 have been activated to “1” because an infrared bullet discharge command ID acknowledgement number IRF ACK and an infrared bullet taking ID number IRR ID are used.

As a result, from the activation indication bits b7, . . . , b0 of the ULPF, the type of data transferred by the robot terminal 1 to the service server 7 (TMD and PSD), the type of command received from the service server 7 (IRF ACK), and the reception of an infrared bullet through the infrared reception unit 15 (IRR ID) can be detected. In this case, the activation indication bits b0 of the DLPF and ULPF are redundant bits, and thus they are inactivated to “0.”

Accordingly, the DLPF and the ULPF are simulacrums (figures, images, shadows and shapes), from which data, a command ID number/the taking ID number, and the reception of the command ID number/the taking ID number, which are included in each piece of packet data, can be entirely and immediately detected.

In this case, in FIG. 5, the left wheel data LWD, right wheel data RWD and gun barrel control data TRD of the DLPF, and the gun barrel monitoring data TMD and proximity sensor data PSD of the ULPF are insignificant data that can be restored using data transferred in the subsequent transmission period, even though they are lost in a current transmission period and thus are not received by a receiving end, or that does not cause great problems, even though they are lost.

In contrast, an infrared bullet discharge command ID number IRF ID and an infrared bullet taking ID number IRR ID are pieces of significant data that must be sent and require acknowledgements of the reception thereof until a receiving end receives them because, if the receiving end does not receive them, an infrared bullet is not actually discharged in spite of the issuance of an infrared discharge command, or the service server 7 erroneously becomes aware that the robot terminal 1 has not been hit by an infrared bullet in spite of the fact that the infrared bullet has hit the robot terminal 1.

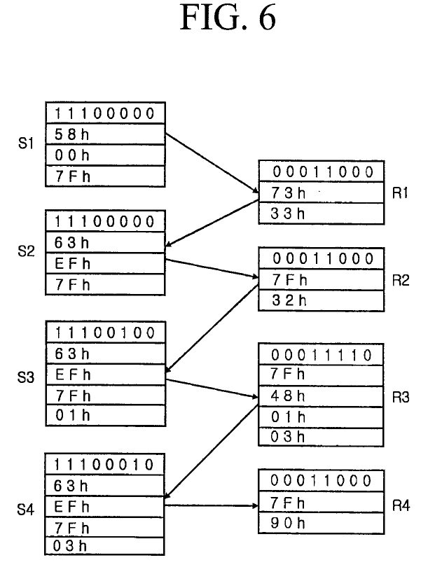

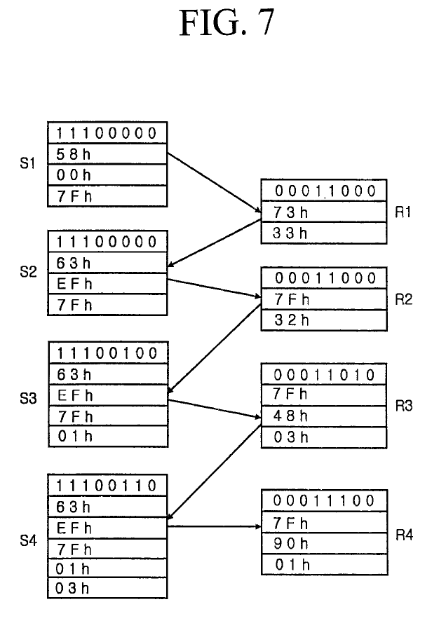

Now, a communication method for certainly sending a command or a reception signal, which must be transferred between the service server 7 and the robot terminal 1, via the DLPF and the ULPF using a UDP/IP method will be described with reference to FIGS. 6 and 7 (in which only a device map section and a payload section are illustrated).

FIG. 6 illustrates the case where a command or a reception signal, which must be transferred, is transferred without transmission loss. In FIG. 6, the DLPF and the ULPF are illustrated in the left/right portion thereof, downlink packets S1, S2, S3 and S4, which are sent by the service server 7 to the robot terminal 1, are illustrated in the left portion thereof, and uplink packets R1, R2, R3 and R4, which are sent by the robot terminal 1 to the service server 7, are illustrated in the right portion thereof.

First, in order to make the robot terminal 1 move to desired locations 58h and 00h using the left wheel 11 and the right wheel 12 and raise the gun barrel at a desired angle 7Fh so as to discharge an infrared bullet using the infrared transmission unit 14, the service server 7 activates left wheel data LWD, right wheel data RWD and gun barrel data TRD-related activation indication bits b7, b6 and b5 by setting the activation indication bits of a packet S1 to “11100000”. Thereafter, the service server 7 creates the packet S1 by inserting related data 58h, 00h and 7Fh into a payload section, and sends the packet S1 to the robot terminal 1 using a UDP/IP method. In this case, since the packet S1 is sent using a UDP/IP method and the packet S1 includes only insignificant data LWD, RWD and TRD, the packet S1 is not sent again, even though it is lost during sending.

Now, in order to send gun barrel angle monitoring data TMD and distance data PSD, measured by the proximity sensor, the robot terminal 1 activates gun barrel monitoring data TMD and proximity sensor data PSD-related activation indication bits b4 and b3 by setting the activation indication bits to “00011000.” Thereafter, the robot terminal 1 creates a packet R1 by inserting related data 73h and 33h, and sends the packet R1 to the service server 1. In this case, since the packet R1 is sent using a UDP/IP method and the packet R1 includes only insignificant data TMD and PSD, the packet R1 is not sent again, even though it is lost during sending.

In the same way, in order to make the robot terminal 1 move to desired locations 63h and EFh using the left wheel 11 and the right wheel 12 and raise the gun barrel at a desired angle 7Fh so as to discharge an infrared bullet using the infrared transmission unit 14, the service server 7 activates left wheel data LWD, right wheel data RWD, and gun barrel control data TRD-related activation indication bits b7, b6 and b5 by setting the activation indication bits of the packet S2 to “11100000,” creates the packet S2 by inserting relate data 63h, EFh and 7Fh into the payload section, and sends the packet S2 to the robot terminal 1 using a UDP/IP method. In this case, since the packet S2 is sent using a UDP/IP method and the packet S2 includes only insignificant data LWD, RWD and TRD, the packet S2 is not sent again, even though it is lost during sending.

Now, in order to sent gun barrel angle monitoring data TMD and distance data PSD, measured by the proximity sensor, the robot terminal 1 activates gun barrel monitoring data TMD and proximity sensor data PSD-related activation indication bits b4 and b3 by setting the activation indication bits to “00011000”, creates a packet R2 by inserting data 7Fh and 32h and sends it to the service server 1. In this case, since the packet R2 is sent using an UDP/IP method and the packet R2 include only insignificant data TMD and PSD, the packet R2 is not sent again, even though it is lost during sending.

Thereafter, in order to make the robot terminal 1 move to desired locations 63h and EFh using the left wheel 11 and the right wheel 12, raise the gun barrel at a desired angle 7Fh to discharge an infrared bullet using the infrared transmission unit 14, and discharge a first infrared bullet using the infrared transmission unit 14 of the robot terminal 1, the service server 7 activates left wheel data LWD, right wheel data RWD, gun barrel control data TRD, and infrared bullet discharge command ID number IRF ID-related activation indication bits b7, b6, b5 and b2 by setting the activation indication bits of a packet S3 to “11100100,” creates packet S3 by inserting related data 63h, EFh and 7Fh and an infrared bullet discharge command ID number 01h into the payload section, and sends it to the robot terminal 1 using a UDP/IP method.

Now, it is assumed that the robot terminal 1 receives a first infrared bullet discharge command IRF ID (significant data) and desires to notify the service server 7 of this fact so as to prevent the service server 7 from sending the first infrared bullet discharge command IRF ID any more, and it is assumed that the robot terminal 1 is hit by a third infrared bullet discharged from the infrared transmission unit 14 of another robot terminal, detects a third hit through the infrared reception unit 15, and desires to send a third infrared bullet taking ID number IRR ID (significant data) to the service server 7.

Then, in order to send an infrared bullet discharge command ID acknowledgement number IRF ACK 01h and an infrared bullet taking TD number IRR ID 03h, together with gun barrel monitoring data TMD and proximity sensor data PSD, the robot terminal 1 activates gun barrel monitoring data TMD, proximity sensor data PSD, infrared bullet discharge command ID acknowledgement number IRF ACK and infrared bullet taking ID number IRR ID-related activation indication bits b4, b3, b2 and b1 by setting the activation indication bits to “00011110,” creates a packet R3 by inserting related data 7Fh, 48h, 01h and 03h, and sends the packet R3 to the service server 1. In this case, the packet R3 is send using a UDP/IP method, and includes significant data IRF ACK and IRR ID.

Thereafter, when the service server 7 receives the packet R3, the service server 7 becomes aware that the First infrared bullet discharge command has been received by the robot terminal 1 because the infrared bullet discharge command ID acknowledgement number IRF ACK-related activation indication bit b2 has been activated in the packet R3, the corresponding data of the packet is “01h”, and this data is identical to the ID number 01h that was used when the service server 7 issued the first infrared bullet discharge command. Accordingly, the service server 7 does not send the first infrared bullet discharge command any more.

Furthermore, since the service server 7 receives the third infrared bullet taking ID number IRR ID, the service server 7 creates a packet S4 by setting an activation indication bit b1 to “1” in the packet S4 and entering “03h” in a corresponding payload portion below the activation indication bit and then sends the packet S4 to the robot terminal 1, so as to notify the robot terminal 1 of the reception.

The robot terminal 1 becomes aware that the service server 7 has received the third infrared bullet taking acknowledgement number IRR ID, sent to the service server 7 by the robot terminal 1, because the infrared bullet taking acknowledgement number IRR ACK-related activation indication bit b1 has been activated in the received packet S4 and a read corresponding data 03h is identical to “03h”. Accordingly, the robot terminal does not send the third infrared bullet taking acknowledgement number IRR ID to the service server 7 any more.

Now, in order to send gun barrel angle monitoring data TMD and distance data PSD, measured by the proximity sensor, the robot terminal 1 activates gun barrel monitoring data TMD and proximity sensor data PSD-related activation indication bits b4 and b3 by setting the activation indication bits to “00011000,” creates the packet R4 by inserting related data 7Fh and 90h into a payload section, and sends the packet R4 to the service server 1. In this case, since the packet R4 is sent using a UDP/IP method and includes only insignificant data TMD and PSD, the packet R4 is not sent again, even though the packet R4 is lost during sending.

As described above, when the transmission method of the present invention is used, significant data is certainly sent in the case where there is no transmission loss.

Next, an embodiment of the present invention capable of certainly sending significant data even in the case where there is transmission loss will be described with reference to FIG. 7. In this case, it is assumed that packets S1, R1, S2 and R2 are not subjected to transmission loss, a packet S3 is subjected to transmission loss, and the remaining packets R3, S4 and R1 are not subjected to transmission loss.

In the case where the robot terminal 1 does not receive the packet S3, sent by the service server 7 to the robot terminal 1, due to a problem with a communication line or the like, and thus significant data (the first infrared bullet discharge command) is not transferred, the robot terminal 1 restores corresponding insignificant data (left wheel data LWD, right wheel data RWD, and gun barrel data TRD) in the current transmission period through interpolation or the like when desired.

Thereafter, the robot terminal 1 continues to perform its duty, so that it activates activation indication bits b4, b3 and b1 so as to send gun barrel monitoring data TMD 7Fh and proximity sensor data PSD 48h, and to provide notification of the taking of a third infrared bullet in the case where the third infrared bullet hits the robot terminal 1, creates a packet R3 by loading gun barrel monitoring data TMD 7Fh, proximity sensor data PSD 48h and a third infrared bullet taking ID number 03h thereon, and sends the packet R3 to the service server 7.

Then, the service server 7 can become aware from the packet R3 that the robot terminal 1 has not received the first infrared bullet discharge command because an activation indication bit b2 corresponding to the first infrared bullet discharge command sent by the service server 7 is inactivated. Furthermore, through the activation of the activation indication bit b1 of the packet R3, the service server 7 becomes aware of the third infrared bullet taking ID number 03h sent by the robot terminal 1.

If so, the service server 7 sends the first infrared bullet discharge command IRF ID again, and, in order to notify the robot terminal 1 of the acknowledgement IRR ACK of the third infrared bullet taking ID number, activates activation indication bits b2 and b1, and sends the packet S4 to the robot terminal 1 with the first infrared bullet discharge command ID number IRF ID 01h and the third infrared bullet taking acknowledgement number IRR ACK 03h loaded thereon.

Now, when the robot terminal 1 receives the packet S4, the activation indication bits b2 and b1 are activated, and the robot terminal 1 can become aware that the service server 7 has issued the first infrared bullet discharge command and the service server 7 has received the third infrared bullet taking ID number sent by the service server 7, when reading the corresponding data 01h and 03h of a payload section. Now, the robot terminal 1 discharges an infrared bullet using the infrared transmission unit 14 when the first infrared bullet discharge command is received, and the robot terminal 1 does not send the third infrared bullet taking ID number to the service server 7 any more when the robot terminal 1 becomes aware that the service server 7 has received the third infrared bullet taking ID number sent by the robot terminal 1.

Thereafter, when the robot terminal 1 receives the first infrared bullet discharge command issued by the service server 7, the robot terminal 1 activates the activation indication bit h2, creates the packet R4 by attaching corresponding data 01h to the packet R4, along with the gun barrel monitoring data TMD 7Fh and the proximity sensor data PSD 90h, and sends the packet R4 to the service server 7, thereby providing notification of the reception of the first infrared bullet discharge command.

Now, when the service server 7 receives the packet R4, the service server 4 becomes aware from the activation indication bit b2 of the packet R4 and the corresponding data 01h that the robot terminal 1 has received the first infrared bullet discharge commands and does not send the first infrared bullet discharge command to the robot terminal 1 any more.

As a result, when the above-described data structure of the present invention is used, significant data can be certainly sent, even though there is transmission loss at the time of sending data using a UDP/IP method. Furthermore, as shown in FIGS. 6 and 7, when the present invention is used, transmission load can be reduced by minimizing size of packet data using only data that needs to be transmitted.

Although the preferred embodiment of the present invention has been described above, it should be noted that the present invention is not limited to the embodiment, but various modifications can be made without departing the spirit of the present invention.

For example, although the robot terminal for a battle game has been taken as an example for ease of description, and the motion control data and sensor data of the robot terminal, such as right and left wheel data, gun barrel angle data, gun barrel monitoring data and proximity sensor data, have been described as being sent and received, the present invention can be applied to the case where the robot terminal makes motion, issues utterance, or display an image so as to perform different applications and the case where audio (such as voice and music) data and video data as well as motion control data are sent and received using a packet method.

Furthermore, although the packet data format for communication between the service server 7 and the robot terminal 1 has been described above, it is possible to allow a Personal Computer (PC) to function as the service server and to perform internal communication between the robot terminal and the PC using the packet data format of the present invention, in the case where the robot terminal 1 contains a local server, like a PC.

Furthermore, although the UDP/IP method has been described above, the present invention can be applied to the cases where Bluetooth, IEEE 802.15.4 (Zigbee method), a wireless USB, or the like is used.

According to the above-described present invention, a UDP/IP method is used for communication between the service server 7 and the robot terminal 1, the activation indication bits of data to be sent are activated and related data is attached, and the reception of significant data, which must be sent, is caused to be acknowledged by a counterpart and the significant data is repeatedly sent until the counterpart receives the significant data, so that it is possible to provide a communication protocol for a robot terminal in which a packet data can be transmitted using a UDP/IP method at high speed, the size of packet data can be minimized, and significant data can be certainly sent.

As a result, it is possible to provide the communication method suitable for a network-based robot terminal system and a data packet data structure for the communication method.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A communication method for a network-based robot system, the network-based robot system including a service server and a robot, wherein:
the communication method is performed in such a way as to send subsequent packet data without waiting for acknowledgement of reception of previous packet data by a counterpart;
each of the pieces of packet data comprises a device map section for storing information about activation, indicating whether data to be sent or received for each of elements of the robot exists, and a payload section for storing data related to activated portions of the device map section; and
in order to send significant data that must be sent,
a transmitting end checks whether the significant data, sent by the transmitting end, has been received by a receiving end, using a response packet sent by the receiving end, based on the information about activation of portions of the device map section, and based on the corresponding significant data existing in corresponding portions of the payload section, and the transmitting end repeatedly sends the significant data until it is acknowledged that the significant data has been received by the receiving end in such a repeating way that the transmitting end activates portions of the device map section corresponding to the significant data that has not be received, creates packet data by including the significant data in corresponding portions of the payload section, and sends the created packet data to the receiving end.

2. The communication method for a network-based robot system as set forth in claim 1, wherein the robot is a robot terminal.

3. The communication method for a network-based robot system as set forth in claim 2, wherein the robot terminal contains a local server that functions as the service server.

4. The communication method for a network-based robot system as set forth in claim 1, wherein the communication is performed using a UDP/IP method.

5. The communication method for a network-based robot system as set forth in claim 1, wherein the activation is designated using an activation indication bit.

6. The communication method for a network-based robot system as set forth in claim 1, wherein the packet data comprises a motion control data that is used to control motion of the robot.

7. A packet data structure for a communication method in a network-based robot system, the communication method being performed in such a way as to send subsequent packet data without waiting for acknowledgement of reception of previous packet data by a counterpart, the network-based robot system including a service server and a robot, wherein each of the pieces of packet data comprises:
a device map section for storing information about activation, indicating whether data to be sent or received for each of elements of the robot exists; and
a payload section for storing data related to activated portions of the device map section.

8. The packet data structure for a communication method in a network-based robot system as set forth in claim 7, wherein the communication is performed using a UDP/IP method.

9. The packet data structure for a communication method in a network-based robot system as set forth in claim 7, wherein the activation is designated using an activation indication bit.
